(19) United States
(12) Patent Application Publication
(10) Pub. No.: US 2019/0318491 A1
(43) Pub. Date: Oct. 17, 2019

(54) SYSTEM AND METHOD FOR GATHERING DATA RELATED TO QUALITY SERVICE IN A CUSTOMER SERVICE ENVIRONMENT

(71) Applicant: Tempo Analytics Inc., Ottawa (CA)

(72) Inventors: Robert LAGANIERE, Gatineau (CA); Luis E. GURRIERI, Kanata (CA)

(21) Appl. No.: 15/780,349

(22) PCT Filed: Jul. 13, 2017
(86) PCT No.: PCT/CA2017/050849

§ 371 Date: May 31, 2018

(51) Int. Cl. G06T 7/521; G06T 7/593; H04N 13/271; G06K 9/00; G06Q 30/00

(52) U.S. Cl. CPC G06T 7/521; G06T 7/593; H04N 13/271; G06K 9/00315; G06K 9/00369; G06Q 30/01; G06K 9/00275

(57) ABSTRACT

Systems and methods relating to gathering data which may be used to produce metrics to analyze customer quality of service. Color-plus-depth sensors are placed facing a service area where customers are located. Images and depth maps of the service area are gathered by the sensors. These data sets are then processed by an on-site processor to isolate each customer and/or each item of interest in each data set. Each detected customer is identified using customer descriptors and the location of each item of interest and of each detected customer is determined relative to a reference point. The extracted data from each data set is uploaded to an off-site server for further processing. The off-site server analyzes the uploaded data to determine customer behavior, customer demographics, customer biometrics, and emotional state. The server can also analyze the uploaded data to determine quality of service (including service time).

### TECHNICAL FIELD

The present invention relates to metrics relating to customer service. More specifically, the present invention relates to methods and systems for gathering data relating to quality, speed, efficiency, and effectiveness of service to customers at a customer service counter.

### BACKGROUND

The quality of the service provided to customers is important to the service industry where, for example, both franchisors and franchisees want to monitor the quality of the service provided to their customers. Good customer service, including fast, efficient service, can ensure a steady stream of sales and customers. However, gathering data to determine whether good customer service is being provided can be problematic. Automated systems should be able to gather data while preserving customer privacy, and also should be non-invasive or non-intrusive. Preferably, such systems should also be able to determine not just the quality of service but also the efficiency of the staff, the service time per customer, the demographic profile of the customers as well as other fine-grained metrics that can be used to analyze customer service as a whole and that can be used to improve the quality of service.

Current systems and methods are suitable for gathering customer data to be used in service analysis. However, in many instances, they do not exploit the full potential of current sensor technology nor of the full potential of current customer data gathering methods. In many systems, the location of sensors (e.g. in service areas, near a service counter) does not allow for the detection of all of a customer's features which may be useful for service monitoring. As well, in many instances, systems are unable to properly isolate/detect and track customer movements, objects, and events of interest. Many systems focus on counting customers and tracking their location in monitored areas. Other systems analyze customer behaviour and determine where customers go in the monitored area and how long they stay at certain locations. Others systems try to extract demographic and behavioural data about individual customers. However, currently no system can provide tracking, behaviour and demographic analysis with a desired level of accuracy.

In terms of implementation, some current systems use stereoscopic camera installed on the ceiling of a facility to track the customers in an area. While such a system can work reliably, the collected depth data cannot be used to understand the longer-term behaviour of customers, their actions, their demographic profile, nor their emotional state. Other systems use color cameras at specific control points in order to capture customer's faces. These captured faces are then used to estimate a customer's demographic profile. However, such systems can, generally, only monitor a very limited area. Also, such systems can only monitor one customer at a time.

Another issue with current technologies is their expense. In many instances, these systems are not only expensive, they also do not meet the accuracy expectations of their client users. In addition the price tag, such systems are unable to work reliably with large numbers of customers. This limitation can be problematic when gathering data for use in time-of-service analyses. Current systems are unable to gather data which can be useful for analyzing the time for each step in a transaction or for analyzing how long a customer spends waiting for service. Current solutions for time analysis are based on acquiring data manually (e.g. using employees and stopwatches to time events). As can be imagined, this approach is always costly and the data gathered is, generally, not representative of real-life day-to-day situations.

From the above, there is therefore a need for better working, more accurate, and more reliable systems and methods for gathering data relating to customer service. Preferably, such systems and methods should be non-invasive, should be able to protect the privacy of customers, should be able to track customers, understand customer behaviour, and gauge customer reactions to the service being provided.

### SUMMARY

The present invention provides systems and methods relating to gathering data and producing customer descriptors. This data and customer descriptors may then be used to analyze customer service metrics. A number of color-plus-depth sensors are placed facing a service area. Visual information and depth maps of the service area are gathered by the sensors producing data sets at regular time intervals. These data sets are then processed by an on-site processor to isolate/detect each customer and/or each item of interest in each sensor output. Each detected customer is identified using customer descriptors with the customer descriptors being used to track the same customer across various frames or across various data sets from other sensors. Similarly, items of interest can also be tracked through various frames or sensor output data sets using object descriptors. These customer and/or object descriptors are then uploaded to an off-site server for further processing.

For each detected customer and object of interest, its location is determined relative to a reference point. The off-site server analyzes the uploaded data to determine customer behavior, customer demographics, customer biometrics, and customer emotional state. The server uses the uploaded data to determine the time spent in each state of the service cycle to produce reports on quality of service, including service time. The produced biometric and demographic data is also analyzed to produce reports on fidelity, shopping habits, and satisfaction of customers served in the monitored area.

The capabilities and advantages of the present invention are legion. The combined use of depth and color data associated to each customer is used by the on-site processors to produce a customer descriptor as a dataset of 3D structure and visual information that contains enough information to identify uniquely each customer and to extract customer features that are useful in the service analysis. In addition, the color-plus-depth information is used to produce object descriptors that can be used to identify and track objects of interest. The extracted customer and object descriptors from the color-plus-depth data are uploaded to an off-site server for further processing. The server analyzes the uploaded descriptors to determine customer behavior and actions, to re-identify and track the same customers or objects throughout various sensor outputs, and to determine each customer's progress in the service cycle. As well, the off-site server analyzes the data to estimate customer demographics, emotional state, and other relevant information. Rich time-based analytics data can thus be extracted from one or more color-plus-depth sensor outputs.

In a first aspect, the present invention provides a system for gathering data relating to a service area, the system comprising:
at least one color-plus-depth sensor for placement behind said service area and facing customers;
a processor for:
   receiving time indexed images from said at least one color-plus-depth sensor;
   processing said images;
   extracting sets of customer descriptors from each of said time indexed images, each set of customer descriptors being for uniquely identifying one of said customers;
   extracting sets of item descriptors from each of said time indexed images, each set of item descriptors being for identifying items in said service area; and
   uploading said sets of customer descriptors and said sets of item descriptors to a server for further processing;
wherein
   said sets of characteristic data preserves customer anonymity.

In a second aspect, the present invention provides a method for gathering data relating to a service area, the method comprising:

a) placing at least one color-plus-depth sensor at a location behind said service area and facing customers in said service area;

b) producing at least one color image and at least one depth map of said service area using said at least one color-plus-depth sensor;

c) using a processor to process said at least one color image to extract a first set of customer descriptors for at least one customer in said service area, said first set of customer descriptor being for describing said at least one customer based on at least one color descriptor for said at least one customer;

d) using a processor to process said at least one depth map to extract a second set of customer descriptors for said at least one customer in said service area, said second set of customer descriptor being for describing said at least one customer based on at least one 3D descriptor for said at least one customer;

e) uploading said first and second sets of customer descriptors to a server for further processing.

Non-transitory computer-readable media having encoded thereon computer-readable computer instructions which, when executed, implement a method for gathering data relating to a service area, the method comprising:

a) placing at least one color-plus-depth sensor at a location behind said service area and facing customers in said service area;

b) producing at least one color image and at least one depth map of said service area using said at least one color-plus-depth sensor;

c) using a processor to process said at least one color image to extract a first set of customer descriptors for at least one customer in said service area, said first set of customer descriptors being for describing said at least one customer based on at least one color descriptor for said at least one customer;

d) using a processor to process said at least one depth map to extract a second set of customer descriptors for said at least one customer in said service area, said second set of customer descriptor being for describing said at least one customer based on at least one 3D descriptor for said at least one customer;

e) uploading said first and second sets of customer descriptors to a server for further processing.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a schematic diagram of a service area showing the placement of the 3D sensors;

FIG. 3 is an image from a sensor and details facial detection and torso detection;

FIGS. 4A-4F are images detailing different image processing steps which may be taken to extract the customer and item descriptors from an image;

FIGS. 5A-5F illustrate multiple images tracking a customer;

FIG. 6 is a state diagram for the various transaction states for use in a retail fast food environment;

FIG. 7 illustrates a retail fast food environment and the transaction states that a customer may undergo; and

FIG. 8 is a block diagram detailing the various modules and components of one aspect of the invention.

### DETAILED DESCRIPTION

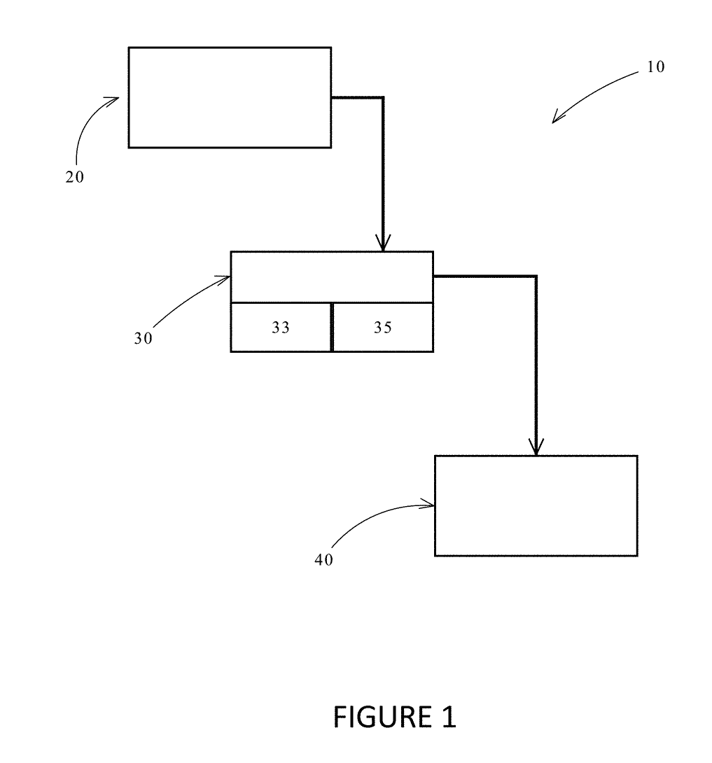

Referring to FIG. 1, a block diagram of a system according to one aspect of the invention is illustrated. The system 10 has a number of sensors 20 deployed facing a service area. The sensors 20 gather images and data sets detailing the service area and send these data sets and images to a processor 30. The processor 30 then isolates items of interest and customers from each data set and associate each item and customer with item descriptors 33 and customer descriptors 35. These descriptors and other data associated with them are then uploaded to an off-site server 40 for further processing.

It should be clear that the term “items of interest” refers to non-human items encountered in the service area that may be relevant to the provision of customer service. As an example, in a quick service restaurant (e.g. a fast food restaurant) setting, a tray laden with food (i.e. a customer's order) placed on a service counter would be an item of interest. Similarly, in a retail setting such as a fashion retail store where the service area encompasses a checkout counter, the items of interest may include products being scanned at the checkout counter. Or, in another example, in a service counter at a government motor vehicle registration department where customers are required to fill out forms, the forms presented by the customers to the service desk/service counter may be included in the items of interest.

The sensors 20 that are used in the invention are color-plus-depth sensors that are able to capture, in a synchronized manner, a color image and a depth map from the exact same, or very similar, point of views. Each color-plus-depth sensor produces two corresponding pixel planes, one containing the color information and the other containing the depth information. These sensors are also known as 3D sensors, depth sensors, or RGBD sensors. While not limited to these technologies, most of such color-plus-depth sensors are based on the following technologies: stereoscopic cameras, structured light sensors, and time-of-flight cameras.

It should be clear that such color-plus-depth sensors capture a sequence of frames that include full color images of the service area with sufficient resolution and color clarity so that at least most of the customers in the service area can be imaged and so that the color of each customer's clothing, as well as the customer's skin tone and facial features, can be determined and isolated. In addition to the color information, the color-plus-depth sensors provide a frame-by-frame depth map of the service area.

It should be clear that while color-plus-depth sensors are preferred, multiple sensors, each of which provides only color or only depth information may be used. For such a configuration, a color sensor would need to be paired with a depth information sensor so that the required data sets are obtained from the sensors. It should be clear that some of the sensors, for this configuration, may be color-only cameras. The color information from such color-only sensors would be coupled or paired with other information (e.g. color-plus-depth information or depth-only information) from other locations and/or sensors.

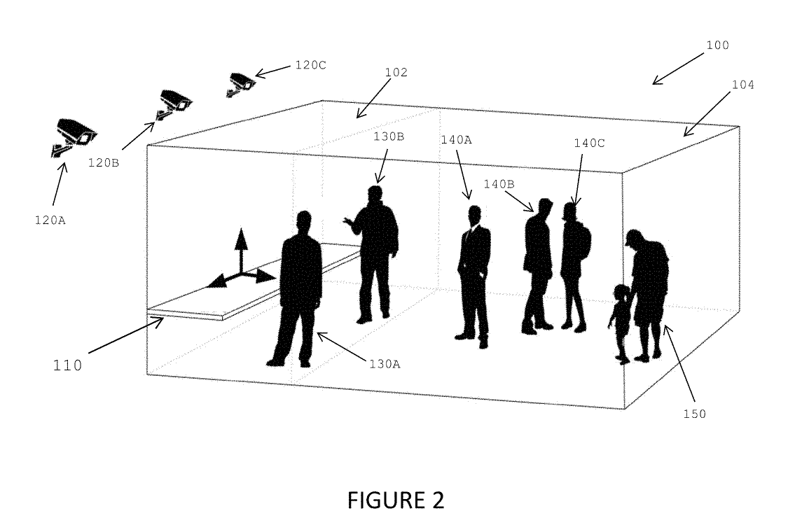

Referring to FIG. 2, a schematic diagram of a service area is illustrated. As can be seen, the service area 100 has a service counter 110 with multiple sensors 120A, 120B, 120C behind the service counter 110. Customers 130A, 130B are at the service counter 110 while customers 140A-140C are awaiting service and customers 150 are at the back of the service area. The sensors 120A-120C are positioned to face the service area 100 and are, preferably, positioned so that they have a high or elevated vantage point above the service area. As such, the sensors 120A-120C are looking down into the service area with a field of view that encompasses the service counter 110, the service area 100, and the various customers 130A, 130B, 140A-140C, and 150.

As noted above, the sensors 120A-120C capture images of the service area as well as provide a depth map for the service area. The sensors can capture images and/or color information of the service area at specific instances in time or it can provide a time lapse record of the service area over a predetermined length of time. Preferably, each frame or image captured by each of the sensors is time indexed so that further processing can ensure a proper sequencing of the various captured images. In one implementation, each image or frame capture (if the sensors provide a video feed of the service area) of service area can be considered as one data set. Each data set can then be processed by the processor to provide a snapshot of the service area at a specific point in time. By processing multiple data sets over time, a sequence of multiple events can then be captured and the various events can then be mined for customer service related data.

It should be noted that while the system illustrated in FIG. 2 uses three sensors, a single sensor may be used as well as multiple sensors. If multiple sensors are used, they may be coordinated to perform image capture, 3D information capture, or frame captures simultaneously (i.e. all the sensors simultaneously capture an image/3D information from different points of view). The viewpoint of the various sensors can be overlapping or they may be independent of each other. Overlapping fields of view (or viewpoints) between the sensors may be of assistance if occlusions or barriers exist in the service area. Similarly, overlapping fields of view can assist in determining customer position and actions or in tracking one or more customers across various frames.

It should be noted that the depth capability of the sensors allows for a common coordinate system to be used across the various frames and/or images. As noted above, the sensors provide a depth map of the service area and this allows for distances between customers and/or items to be calculated. The common coordinate system across the various images and frames allows for the determination of changes in position over time for each customer and/or item of interest.

To assist in tracking detected customers across the various images or frames, it is preferred that the various images or frames sent from the sensors to the processor be time stamped or at least have some indication of sequencing. This allows each data set (each frame or image being a self-contained data set) to be identified relative to other data sets in terms of sequence.

Once an image or frame has been captured by one of the sensors, a processor receives this image or frame for processing. It should be clear that by the term “processor”, included is the configuration of using multiple processors. As an example, each color-plus-depth sensor may have an embedded processor (i.e. a smart camera) and the multiple sensor configuration provides for a multiple processor system. Preferably, the processor is on-site with the sensors. The processor has sufficient processing power to perform image processing functions as well as image extraction and color and depth calculations. The processor implements methods to isolate and/or detect customers and items of interest in each image or frame. In addition, the processor extracts the characteristics of each detected customer so that a unique customer descriptor can be formulated for that detected customer. The characteristics which may be extracted for each detected customer may include 3D structure and color of the customer's clothes and body parts, the customer's facial features, skin tone, head shape/size, torso shape/size, a customer's garment's texture, a customer body's or object's interest points (key points), a customer's body pose, and a customer's facial expression.

The extracted customer characteristics are embedded into a descriptor vector or a descriptor matrix of numbers containing any combination of low-level information such as color and 3D point clouds, local image-based features such as color histograms, histograms of oriented gradients, local binary patterns, oriented filter responses, and local object-based features such as facial features (eyes, nose, mouth), arms or hands.

It should be clear that, in one embodiment, some customer characteristics may only be extracted once a customer is close enough to the sensors for a good image of the customer to be taken. Referring to FIG. 2, the service area 100 may be divided into two distinct subareas—a waiting area and a counter area. As can be imagined, the counter area 102 is close to the service counter 110 while the waiting area 104 is close to the back of the service area 100 (i.e. the waiting area is where the customers 150 are located in FIG. 2). Customers in the counter area 102 can be imaged with their characteristics being visible and therefore extractable from the image.

As noted above, customer body size and/or body shape may be used in the customer descriptors. Since each customer's torso can be detected, each torso can be described by geometric models that fit the customer's body dimensions. These models can also form part of the customer descriptor.

In addition to the customer body size/shape, other geometric models may be used to encode a customer's action/posture. For example, using the extracted visual and depth information, a customer's hand can be detected and tracked in order to identify specific actions such as paying for a purchase. The customer's action/posture can also be encoded within the customer's descriptor.

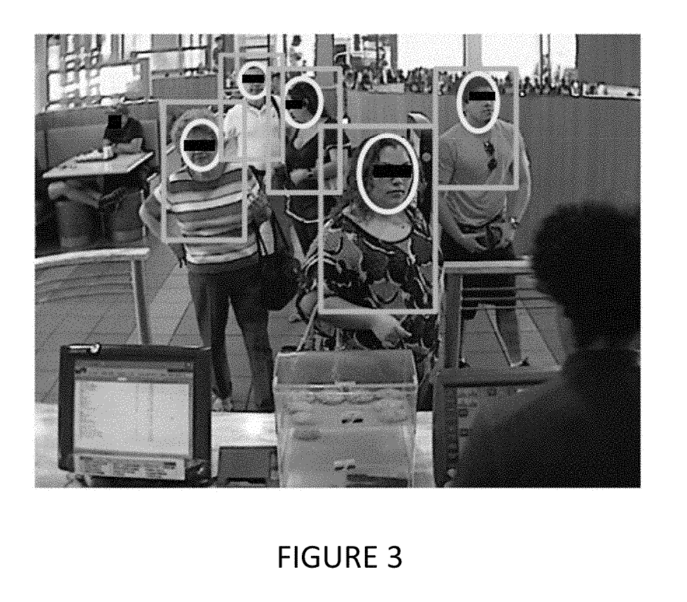

Referring to FIG. 3, an example of an image captured by the sensors and analyzed by the processor is illustrated. As can be seen, the processor has detected faces of customers in the image (circled in FIG. 3) along with the torsos of these customers (squares in FIG. 3). The image also has a depth map describing the 3D shape and position of customers. These detected customers are in the counter area, i.e. near the service counter 110. Based on at least a few of the following, the detected faces, the detected torsos associated with each face, the colors and textures associated with each face and/or torso (e.g. the customer's clothing), the 3D shape information associated with each face and/or torso, the processor can create a unique customer descriptor that describes each detected customer without referring to the detected customer's image. Each customer can then be tracked across the various images using this unique customer descriptor.

From the above, it should be clear that each customer descriptor is considered unique (i.e. cannot be/will not be confusable with descriptors for other detected customers) where the customer descriptor contains visual and 3D information. As such, when the customer descriptor uses 3D information (i.e. shape and distance information) and appearance information (visual information) for each detected customer, the resulting descriptor is unique for each customer. As an example, two specific customers might look alike in any image and may be physically close to each other in the service area. However, unless these specific customers overlap in space and time (i.e. fuse together) for all the sensors detecting them, each of these specific customers will have a different and unique customer descriptor. The system will produce such unique customer descriptors using both the visual and 3D information associated with each specific customer.

It should also be clear that the customer descriptor may be semi-unique in embodiments or instances where 3D information is not available as some customers may be described only by their visual descriptor. Also, in some instances, more than one customer may produce similar visual descriptors, depending on the uniqueness or non-uniqueness of a customer's visual characteristics. These visual characteristics may include clothing color, height, facial expression, skin tone, and other visual cues.

To enhance the uniqueness of the customer descriptor and to assist in the tracking of the detected customers, a uniform coordinate system may be used across the various images. While this has been noted above, to clarify, this coordinate system may reference the location of each customer and/or item of interest relative to a fixed point of reference. In one embodiment, the fixed point of reference is the service counter 110. As such, the distance between each customer and the service counter is calculated and is associated with the relevant customer descriptor. Similarly, the distance between each item of interest and the service counter is also calculated and associated with the relevant item descriptor. In addition to the distance between a customer/object to the customer counter, each customer/object's height relative to the service counter can also be calculated and entered into the relevant descriptor. If the customer or object is at the counter or on the counter, then that customer/object's position along the counter can also be calculated and associated with the relevant customer descriptor or item descriptor.

To clarify the above reference to a customer/object's height relative to the fixed point of reference, calculating this height can be simple. Since a uniform coordinate system is used across the various images, each customer's height (with allowances for foreshortening due to the sensor perspective) can be estimated relative to the fixed point of reference. In one embodiment, a customer's height is detected by averaging the distance of the customer's head to the reference service counter height over multiple detections/frames. It should be clear that the reference counter height is known from an initial calibration and from the initial setup of the sensors. As customers are moving through the service area, estimates of each customer's height can be updated, taking into account the possibility that people are not always standing straight.

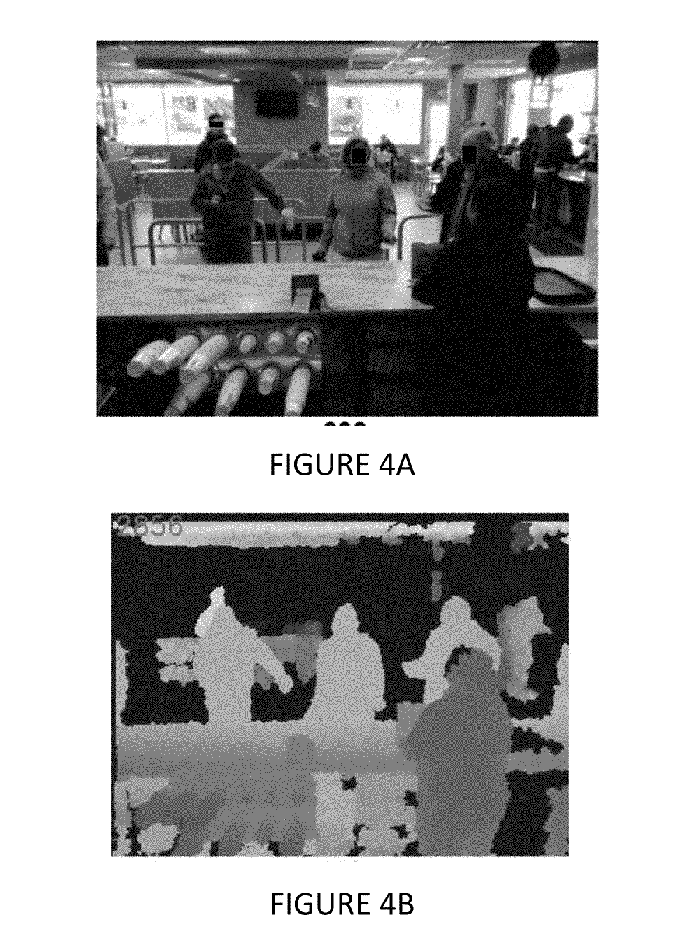

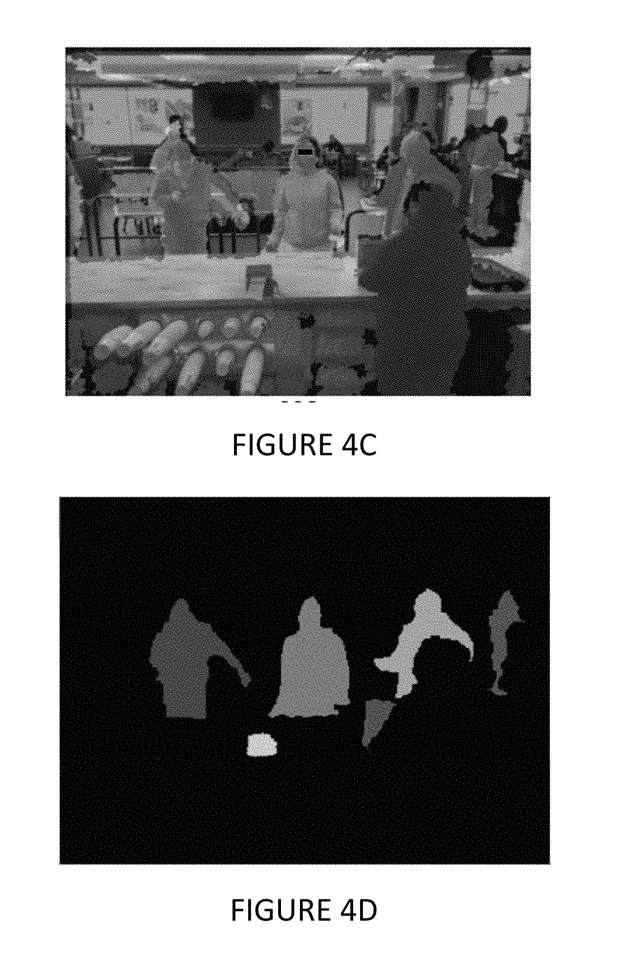

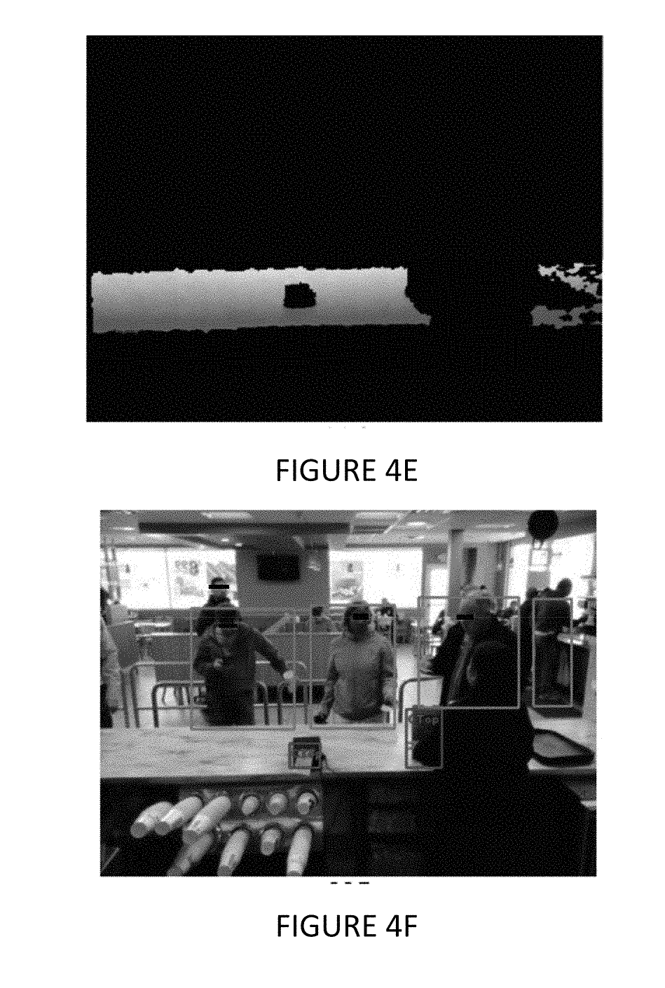

As noted above, the depth map is produced by the sensors to assist in customer and/or item detection. Referring to FIG. 4A, an image of a service counter showing the color information captured from a sensor's perspective is illustrated. Referring to FIG. 4B, an image of a service counter showing the depth information captured from a sensor's perspective is illustrated. The dense depth map can be used to segment customers from the backgrounds by using predetermined 3D shape models (see FIG. 4C). Note that the visual information may also be used to validate the extracted 3D information (i.e. that the information belongs to a specific customer) and to refine the customer extraction process. Based on these results, the location of each detected customer in the scene can then be determined (see FIG. 4D). To assist in the location and coordinate calculations, the service counter's location relative to the sensor can be determined (see FIG. 4E where the location of the service counter is extracted from the image). Finally, image of the scene and the color and depth information encapsulated in the image can be used to detect the different customers present as well as the various items of interest on the service counter (see FIG. 4F where the customers are blocked off in purple boxes while the items on the counter are blocked off in blue boxes). Particular note should be made of the item in the middle of the service counter and which can clearly be seen in FIGS. 4D and 4E.

Once the processor has processed each image to create a descriptor for each detected customer and each item of interest, these descriptors and a timestamp or sequence indicator are then uploaded to at least one server for further processing. Preferably, the server is off-site and is at a network accessible data and processing center. This allows most of the intensive processing to be performed off-site. It should be noted that only the customer descriptors are uploaded and not the source images or frames from the sensors. This ensures that customer images never leave the site and customer privacy is preserved.

Once the descriptors are uploaded, the server receives the customer descriptors for each sequenced/time stamped data set and analyzes each data set relative to other data sets in the sequence. This analysis allows the server to track specific customers as they enter the service area, wait for service, receive service, pickup orders, and leave the service area. Depending on the circumstances, of course, these specific customers may need to be served multiple times by the staff (e.g. once to place an order, a second time to pick up part of an order, and a third time to pick up the rest of the order). The server can also track these various actions.

To track specific customers across the various data sets (each data set corresponding to a specific image and/or frame from the sensors) each customer descriptor is correlated with other customer descriptors from other data sets. Customer descriptors that are similar to one another are grouped together and an exact match between customer descriptors indicates that the same customer is being described. Thus, since the customer descriptor may include location data for the customer, the customer's location can be tracked across different data sets and, essentially, across different images.

An exact match between customer descriptors may not be necessary to conclude that the multiple detections of the same customer in different datasets are being described by exactly the same customer descriptors. A predetermined threshold may be used to conclude that very similar descriptors relate to the same customer. As an example, if a customer descriptor for data set A is 80-90% similar to another customer descriptor in data set B (with data set A relating to an image that precedes in time an image to which data set B relates) and no other customer descriptor is similar to these descriptors in either data set, then it would be safe to conclude that they both relate to the same customer.

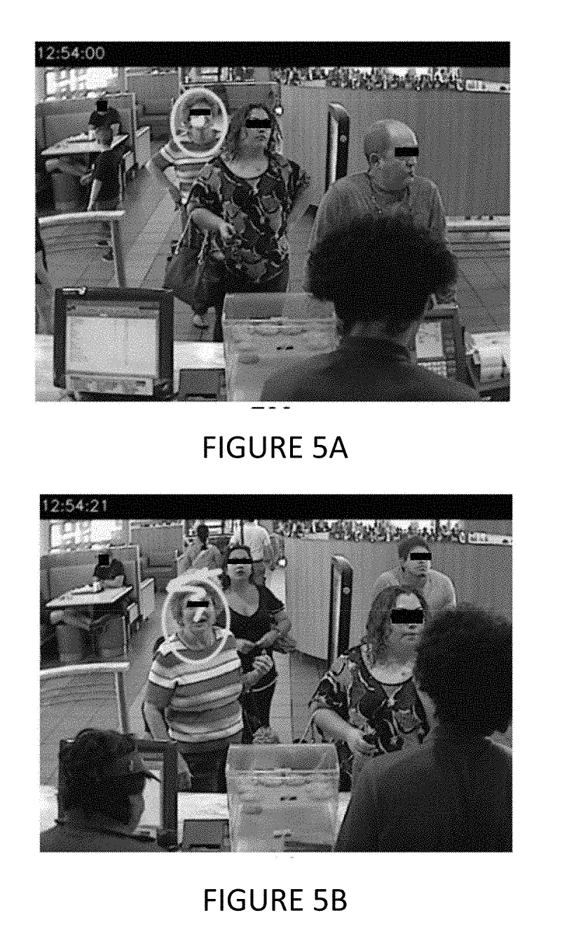

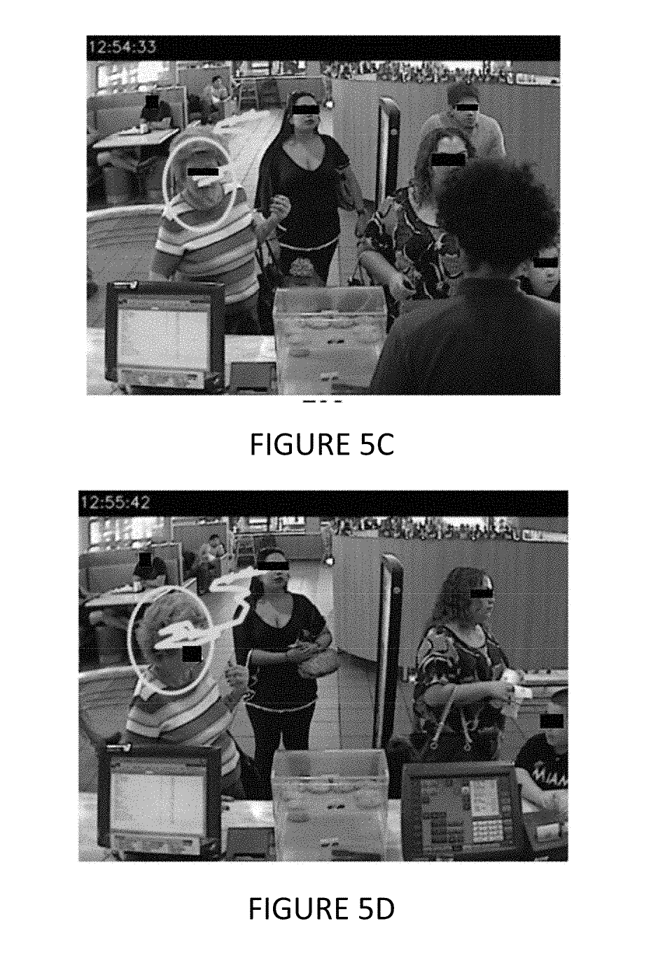

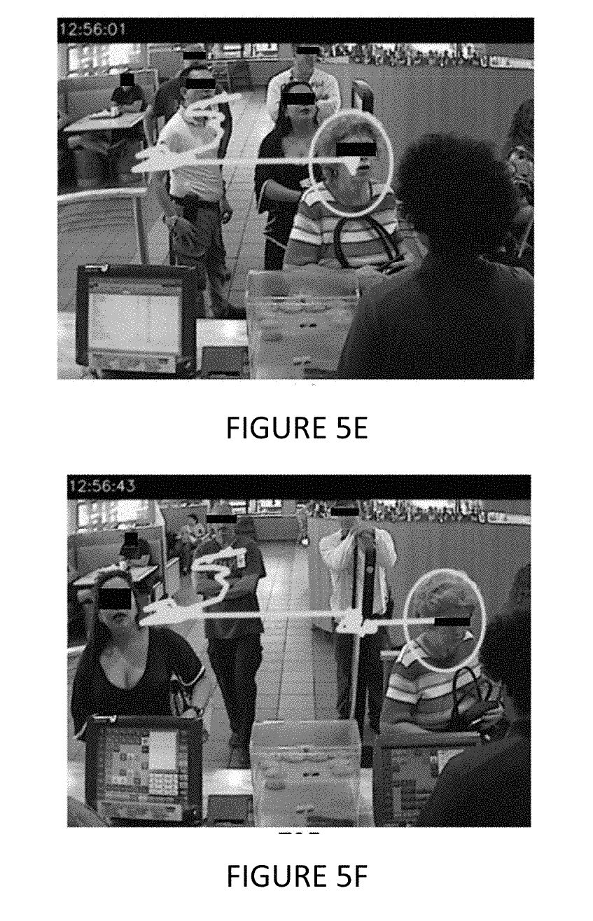

To illustrate the above concept of tracking a specific customer across various data sets, with each data set being associated with a specific frame, FIGS. 5A-5F are provided. In FIG. 5A, a specific customer is detected. Suitable customer descriptors are created for this specific customer for each of the different images. In FIGS. 5B and 5C, the specific customer has moved forward and is now closer to the service counter. Of course, the customer descriptor for this customer for FIGS. 5B and 5C should be very similar to one another with the exception that the customer's location has changed between the images. From FIGS. 5D-5F, the specific customer has moved across the service counter. This specific customer may be in different transaction states in these different images. As an example, the customer is waiting in FIG. 5A and is ordering in FIG. 5C and 5D. The customer may then be paying for her purchase in FIG. 5F. The different states of the service transaction and the concept behind their use are explained below.

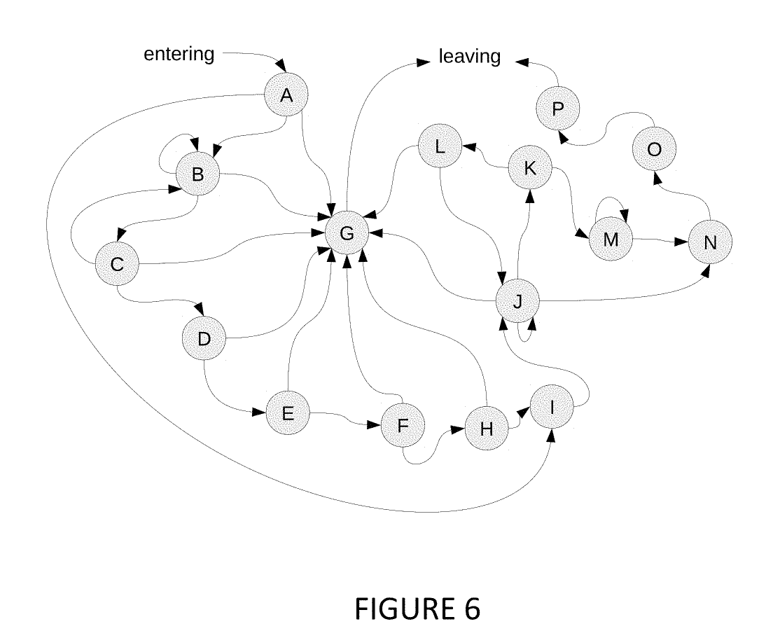

To assist in being able to track customers within the service area, each customer is assigned a transaction state while the customer is within that service area. This ensures that, for classification purposes, each customer is classified as being in one of multiple possible discrete transaction states. As an example, with reference to the state diagram in FIG. 6, in a Quick Service Restaurant (QSR) retail environment, a customer may be in any one of the following transaction states:

State A: Entering the service's area;

State B: Waiting in line;

State C: Moving in the waiting line;

State D: Walking to the cashier's counter;

State E: Placing an order;

State F: Paying for the order;

State G: Leaving the tracking area without being served;

State H: Walking away from the cashier's counter;

State I: Walking to pickup area to wait for the order;

State J: Waiting for the order away from the pickup counter;

State K: Walking towards the pickup counter;

State L: Walking away from the pickup counter;

State M: Walking to the pickup counter;

State N: Picking up the order;

State O: Walking away from the pickup counter with the order; and

State P: Walking away from the tracking area after being served.

As can be seen, a customer can thus be assigned a specific sequential transaction states. This scheme indicates what a customer may be doing and, by correlating with the time stamps or the sequencing of the data sets, the length of time for each transaction state may be determined.

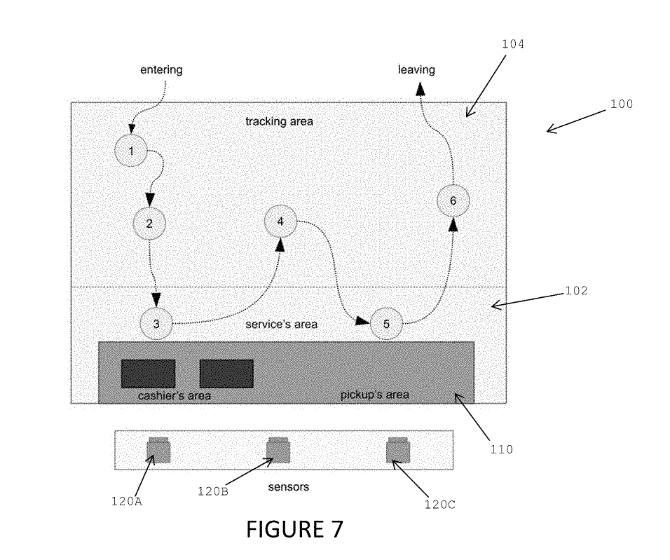

Referring to FIG. 7, a typical transaction flow for a customer in a quick service type restaurant that uses the present invention is illustrated. As can be seen, the service area 100 is divided into two areas of interest, area 102 and area 104, and that a service counter 110 is present. In this example, the customer transitions from state (1) (entering the service area) to state (2), lining up to receive service. The customer then transitions to state (3), that of placing an order at the cashier's area. From here, the customer moves to state (4), walking away from the cashier's area to wait for the order. The customer then transitions to state (5), moving to the service counter to pick up the order when it is ready. Once the order has been picked up, the customer transitions to state (6), that of walking away from the service area after being served. As may be imagined, other businesses relying on service counters, (e.g. a bank service line) may have different state graphs with different actions associated with each state.

The server may also determine a customer's transaction state based on an analysis of data sets that are close to one another in time. As an example, assuming a specific customer has been detected and is tracked across multiple data sets, if the customer descriptor indicates that the customer is adjacent to the service counter and that the customer has an outstretched hand, the server may determine that the customer may be in the act of paying for a purchase. This may be probable if the customer's previous location was that of a line up as the customer was waiting to order. Similarly, if a customer descriptor indicates that the customer's face is not visible (i.e. the customer is facing away from the sensors) and that the customer is moving away from the service counter, this may indicate that the customer is leaving the service area. By assessing this data from a customer descriptor in conjunction with an immediately preceding customer descriptor that locates the customer at the service counter along with an item of interest in the counter, it can be concluded that the customer has picked up his order and is walking away from the counter.

In addition to analyzing the customer's actions based on the customer descriptor, a customer's actions over time can also be analyzed. Actions of customers in the service area can be determined by using information collected in the customer descriptor, such as location, 3D information, and color. A silhouette of each customer tracked is extracted and localized feature points from the color and dense 3D mapping of the customer are used to produce a spatial descriptor of the customer's pose. The progression of movement of each customer can be tracked over time to produce an action descriptor. This action descriptor can be formulated by stacking a succession of customer pose descriptors. The action dataset is then classified using a trained reference set of the most likely actions to occur in a service setting, e.g., walking, lining up, placing an order, paying, etc.

It should be clear that the server does not merely track each customer but also items of interest in the service area. These items, including those detected on a service counter, may be similarly tracked to determine if a customer is transitioning from one transaction state to another. As an example, if, in one data set, a customer descriptor indicates that the customer is at the service counter and there is an item of interest on the counter and, in the next data set, the item of interest is gone and the customer is moving away from the counter, then it can be concluded that the customer has picked up the item and is leaving. Similarly, the presence of one or more items of interest on the service counter may be used as an indication that a customer has been served. By determining the amount of time between data sets where the customer had ordered and the data sets where the item of interest appeared on the service counter, the service efficiency and time for service can be determined.

In some cases, the server may detect and track individuals who do not complete a transaction or request for service, but who are accompanying the customer who actually does those actions. In other situations, such as in a situation with a group of customers, one person may place an order while another customer, usually someone that was accompanying, picks up the order. In most of these different cases, the system may use location proximity and other heuristics to identify and trace a complete transaction.

It should be noted that, in addition to tracking customers across the various images and over time, the server may also be used to gather demographic and biometric data about the customers.

The received customer descriptor that includes both visual and 3D shape information can also be used to estimate the probability of each customer's gender and/or ethnicity. To this end, this rich descriptor is used to train a classifier that can also use higher level features such as customer's facial features and/or torso characteristics to achieve more accurate gender and/or ethnicity estimates. Note that such gender and/or ethnicity determinations are not meant to be completely accurate. The customer's gender and/or ethnicity are therefore implicitly encoded into the customer descriptor. As an example, in one implementation, specific customer features (e.g. facial features, body features) are embedded in the customer descriptor. Thus a customer's specific facial features (e.g. facial shape, eye shape, skin tone, etc.) may be embedded in the customer descriptor along with specific body features (e.g. body shape, limb shape, head shape, etc., etc.). Thus, from such embedded features, customer demographics, customer emotions, and customer behaviour can be extracted and/or extrapolated.

In addition to the gender and/or ethnicity of each customer, the server may assess each customer's emotional state based on the customer's descriptor, facial features and possibly the customer's body language/demeanour. Customer emotional state is learned by training a classifier using past observations. The customer's probable emotional state is therefore implicitly encoded into the customer descriptor. To this end, in one implementation, the customer descriptor includes data detailing the customer's body language, the customer's body state, the customer's body status (e.g. whether the customer is bending, upright, sitting, etc.), the customer's hand position and/or placement (e.g. does the customer have their hands folded, by their side, on a counter, etc., etc.), and customer head position (e.g. is the customer's head tilted to one side, upright, tilted back, etc., etc.).

The classifier and its associated training algorithm can be of any type such as, but not restricted to, Support Vector Machine, decision tree, boosted cascade of classifiers, or convolutional neural network.

In one alternative, biometric data can also be gathered by using the customer descriptor to locate the customer in the scene along with their 3D information. The customer's body shape type can be estimated by extracting a customer's silhouette from the color detection and then correlating this information with the customer's height. These data points can be encoded and embedded into the customer descriptor.

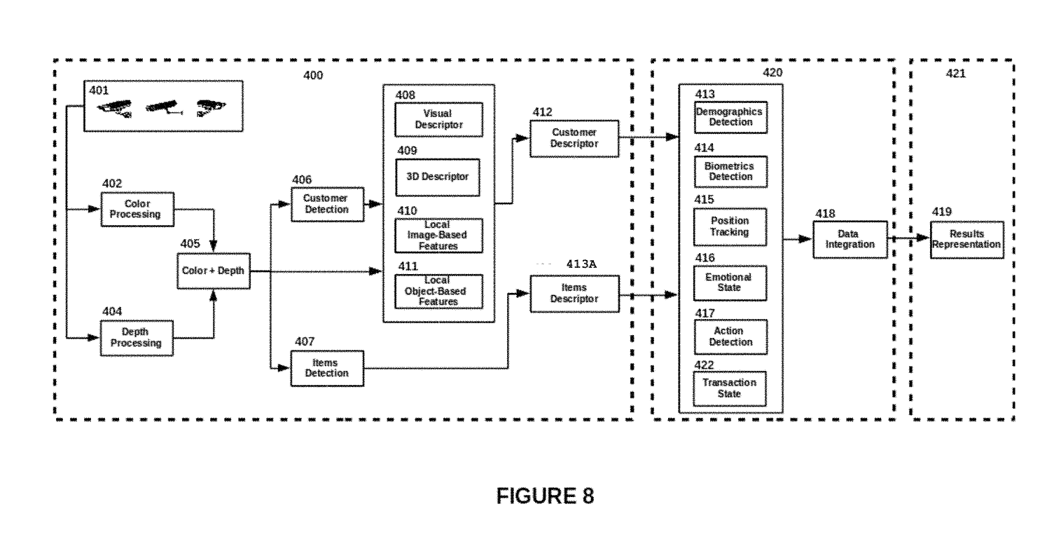

To implement the above described system and methods, a system such as that illustrated in the blocks of FIG. 8 may be used.

Referring to FIG. 8, a block diagram of the various modules and components of one aspect of the invention is illustrated. The system components on-site are in block 400. The sensors array 401 provides time-indexed data sets composed by color and depth information of the service area from various points of view. The color processing block 402 produces time-indexed color images adequate for color feature extraction, while the depth processing block 404 produces time indexed depth maps of the service area. Depth and color are integrated, by time-index and by sensor in block 405, which produces color-plus-depth datasets. The customer detection block 406 uses the color-plus-depth datasets to detect customers in each time-index from each sensor, and to detect items of interest.

It should be clear that visual and 3D descriptors are produced by different blocks or modules. Each customer detected in each image, from each sensor, and in each time-index, is processed by block 408 to produce visual descriptors. These visual descriptors contain information such as color histograms of the regions of interest for different customers regions of interest. These color histograms can be used to dynamically extract the customer image from the image background, thereby preserving the texture corresponding to each customer's body for future classification.

For 3D information, block 409 generates a 3D descriptor that contains location information of the customer in the service area. The location information can be extracted from the image by using the service counter (or some other agreed upon fixed reference point) as a spatial reference. Dense cloud points of each customer location in the scene can thus be created and can be used for off-site classifiers.

The local image-based and object-based features are produced in blocks 410 and 411, respectively. These features are produced when possible as they are useful to enrich both customer and/or item descriptors with detailed features. These detailed features can be used to identify and to differentiate between customers using off-line processors.

To help formulate the customer descriptors, color-plus-depth datasets produced in block 405 are used by blocks 408-411, along with information produced in block 406, to localize customers in each image. The output of blocks 408-411 is combined by block 412 to produce rich customer descriptor datasets per time-index. These customer descriptors are then transmitted to a remote server for processing.

For item descriptors, block 413A processes the image and 3D information to localize items of interest in time-indexed images where those items have been detected. Block 413A then produces an item descriptor dataset and this dataset is transmitted to remote servers alongside the customer descriptors for further processing.

One or more servers located off-site, as illustrated in block 420, process the combined information accumulated in the customer and object descriptors for each time-index. Block 413 processes the received customer descriptors to estimate the demographics of the monitored customers (e.g. their gender, ethnicity, and gender). Block 414 processes the customer descriptors to estimate their biometric features (e.g. height, body constitution). Block 415 processes customers and item descriptors to classify and to track movements of customers and items of interests in the monitored area. Block 416 uses parts of the customer descriptor information to classify the emotional estate of the people being monitored. Block 417 processes the received descriptors to detect and classify customer actions. Block 422 determines the transaction state for each customer based on the information available in the customer and item descriptors. Finally, block 418 integrates the information produced by blocks 413-417 and block 422 to generate analyses of the transactions that are occurring in the monitored area. Results are sent to each system client location (represented by block 421) and displayed according to each client's needs by block 419.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for gathering data relating to a service area, the system comprising:
at least one color-plus-depth sensor for placement behind said service area and facing customers;
a processor for:
receiving time indexed images from said at least one color-plus-depth sensor
processing said images;
extracting sets of customer descriptors from each of said time indexed images, each set of customer descriptors being for uniquely identifying one of said customers;
extracting sets of item descriptors from each of said time indexed images, each set of item descriptors being for identifying items in said service area; and
uploading said sets of customer descriptors and said sets of item descriptors to a server for further processing;
wherein
said sets of customer descriptors preserve customer anonymity.

2. The system according to claim 1, wherein said color-plus-depth sensor is of a type that is at least one of:
RGB+D sensors;
stereoscopic cameras;
structured light sensors; and
time of flight sensors.

3. The system according to claim 1, wherein said set of customer descriptors is based on at least one of:
a 3D structure and color of a customer's clothes;
a 3D structure and color of a customer's body parts;
local image-based color histograms;
local image-based histograms of oriented gradients;
local image-based binary patterns;
local image-based oriented filter responses;
at least one local object-based facial feature;
at least one object-based arm
at least one object-based hand;
at least one interest point on a customer's body;
a customer's face;
a customer's head shape;
a customer's head size;
a customer's torso shape;
a customer's torso size;
a customer's skin tonality;
a customer's facial expression;
a customer's location relative to a predetermined reference point;
color descriptors of different parts of a customer in said images;
a customer's height; and
a customer's location in said service area.

4. The system according to claim 1, wherein said at least one color-plus-depth sensors has a field of view which overlaps a field of view of at least one other color-plus-depth sensor.

5. The system according to claim 1, wherein said at least one color-plus-depth sensors has a field of view which fully overlaps a field of view of at least one other color-plus-depth sensor.

6. The system according to claim 3, wherein said predetermined reference point is a service counter in said service area.

7. The system according to claim 1, wherein said service area is divided into two sub-areas, one of said two sub-areas being closer to said at least one sensor.

8. The system according to claim 1, wherein said server processes data received from said processor to determine at least one of:
customer demographics;
customer transaction state;
customer satisfaction;
average service time to serve a customer;
customer biometrics;
customer actions; and
customer emotional state.

9. The system according to claim 1, wherein said color-plus-depth sensors are behind and above a service counter in said service area.

10. The system according to claim 1, wherein said color-plus-depth sensors produce at least one depth map.

11. A method for gathering data relating to a service area, the method comprising:
a) placing at least one color-plus-depth sensor at a location behind said service area and facing customers in said service area;
b) producing at least one color image and at least one depth map of said service area using said at least one color-plus-depth sensor;
c) using a processor to process said at least one color image to extract a first set of customer descriptors for at least one customer in said service area, said first set of customer descriptors being for describing said at least one customer based on at least one color descriptor for said at least one customer;
d) using a processor to process said at least one depth map to extract a second set of customer descriptors for said at least one customer in said service area, said second set of customer descriptor being for describing said at least one customer based on at least one 3D descriptor for said at least one customer;
e) uploading said first and second sets of customer descriptors to a server for further processing.

12. The method according to claim 11, wherein said sets of customer descriptors is based on:
a 3D structure and color of a customer's clothes;
a 3D structure and color of a customer's body parts;
local image-based color histograms;
local image-based histograms of oriented gradients;
local image-based binary patterns;
local image-based oriented filter responses;
at least one local object-based facial feature;
at least one object-based arm
at least one object-based hand;
at least one interest point on a customer's body;
a customer's face;
a customer's head shape;
a customer's head size;
a customer's torso shape;
a customer's torso size;
a customer's skin tonality;
a customer's facial expression;
a customer's location relative to a predetermined reference point;
color descriptors of different parts of a customer in said images;
a customer's height; and
a customer's location in said service area.

13. The method according to claim 11, wherein said at least one color image is segmented to isolate said at least one customer in said color image.

14. The method according to claim 11, wherein said server is remote from said at least one color-plus-depth sensor.

15. The method according to claim 11, further including a step of using said processor to process said at least one color image to extract item descriptors for at least one item of interest in said service area, said item descriptor being for describing at least one item for use by said at least one customer.

16. The method according to claim 11 wherein said server tracks said at least one customer across multiple color images using said customer descriptor.

17. Non-transitory computer-readable media having encoded thereon computer-readable computer instructions which, when executed, implement a method for gathering data relating to a service area, the method comprising:
a) placing at least one color-plus-depth sensor at a location behind said service area and facing customers in said service area;
b) producing at least one color image and at least one depth map of said service area using said at least one color-plus-depth sensor;
c) using a processor to process said at least one color image to extract a first set of customer descriptors for at least one customer in said service area, said first set of customer descriptors being for describing said at least one customer based on at least one color descriptor for said at least one customer;
d) using a processor to process said at least one depth map to extract a second set of customer descriptors for said at least one customer in said service area, said second set of customer descriptor being for describing said at least one customer based on at least one 3D descriptor for said at least one customer;
e) uploading said first and second sets of customer descriptors to a server for further processing.
